(19) United States
(12) Patent Application Publication
(10) Pub. No.: US 2024/0176357 A1
(43) Pub. Date: May 30, 2024

(54) SYSTEM FOR AVOIDING COLLISION OF AUTONOMOUS VEHICLE AND CONTROL METHOD OF THE SAME

(71) Applicant: HYUNDAI MOBIS CO., LTD., Seoul (KR)

(72) Inventors: Min Cheol JEONG, Yongin-si (KR); Hyun Seong MOON, Yongin-si (KR)

(73) Assignee: HYUNDAI MOBIS CO., LTD., Seoul (KR)

(21) Appl. No.: 18/519,953

(22) Filed: Nov. 27, 2023

(30) Foreign Application Priority Data
Nov. 28, 2022 (KR) 10-2022-0161466

(51) Int. Cl. G05D 1/02; G08G 1/16

(52) U.S. Cl. CPC G05D 1/0289; G05D 1/024; G08G 1/166

(57) ABSTRACT

A system for avoiding a collision of an autonomous vehicle that drives through a space in which a plurality of zones have been set including a first sensor configured to detect objects disposed in a first detection area, a second sensor configured to detect another vehicle disposed in a second detection area, and a processor configured to control an autonomous driving operation of the autonomous vehicle by distinguishing between an object detected by the first sensor and the another vehicle detected by the second sensor and control an entry of the autonomous vehicle through the autonomous driving operation into any one zone of the plurality of zones in response to a driving signal that is received from a control server.

### CROSS-REFERENCE TO RELATED APPLICATION

This application claims priority from and the benefit under 35 USC § 119(a) of Korean Patent Application No. 10-2022-0161466, filed on Nov. 28, 2022, the entire disclosure of which is incorporated herein by reference for all purposes.

### BACKGROUND

### 1. Field

Exemplary embodiments of the present disclosure relate to a system for avoiding a collision of an autonomous vehicle and a control method thereof, and to a system for avoiding a collision of an autonomous vehicle and a control method thereof, which avoid a collision between vehicles that drive within a predetermined space and control the driving of the vehicles.

### 2. Description of the Related Art

A vehicle changes its driving as the steering wheel of the vehicle is manipulated by a driver, assists the driver, and drives up to its destination. The vehicle includes a plurality of sensors and cameras, and controls the driving of the vehicle by recognizing a surrounding situation and detecting a surrounding object that moves.

Furthermore, an autonomous driving technology in which the vehicle changes its driving direction and autonomously drives, while detecting a surrounding situation, although a driver does not manipulate the steering wheel as described above tends to be applied to the vehicle step by step.

In an industrial site, a process task is performed by investing various robots and autonomous vehicles. The robot is fixed to a worktable, and it performs a process task or performs a designated operation while driving through an area based on the autonomous driving technology.

In an industrial site, an autonomous robot, an autonomous vehicle, and a common vehicle are mixed and perform designated tasks, respectively.

In such an industrial site, worktables for the progress of a process are installed in multiple areas within a space. Multiple materials or work products for a process task are loaded on the worktables. As a plurality of vehicles (e.g., an autonomous vehicle, an autonomous robot, and a common vehicle) drive within a limited space, a risk of a collision between the vehicles is present. Accordingly, a technology for preventing such an accident is applied to the industrial site.

In such an industrial site, a vehicle is constructed to detect its surroundings through a sensor in order to avoid a collision. However, in general, when detecting a surrounding worktable or luggage, the vehicle stops its driving by recognizing the surrounding worktable or luggage as an obstacle. Accordingly, there is a problem in that the progress of a task is delayed.

Accordingly, in order to prevent an autonomous vehicle from stopping its driving due to unnecessary detection, the autonomous vehicle drives in the state in which the size of a detection area of a sensor has been reduced. However, the autonomous vehicle does not detect another autonomous vehicle even in the state in which the another autonomous vehicle has approached the autonomous vehicle because the size of the detection area is excessively reduced. Accordingly, there is a problem in that an accident in which the autonomous vehicles collide against each other occurs.

Accordingly, there is a need for a method of controlling the driving of an autonomous vehicle by recognizing a surrounding vehicle or robot while minimizing the stop of the autonomous vehicle attributable to the detection of an obstacle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a system for avoiding a collision of an autonomous vehicle that drives through a space in which a plurality of zones have been set including a first sensor configured to detect objects disposed in a first detection area, a second sensor configured to detect another vehicle disposed in a second detection area, and a processor configured to control an autonomous driving operation of the autonomous vehicle by distinguishing between an object detected by the first sensor and the another vehicle detected by the second sensor and control an entry of the autonomous vehicle through the autonomous driving operation into any one zone of the plurality of zones in response to a driving signal that is received from a control server.

The autonomous vehicle and the another vehicle may each include an indication part and the second sensor is configured to detect the another vehicle by detecting the indication part of the another vehicle.

The indication part may include a reflective material.

The second sensor may be a LIDAR sensor that detects the indication part and the second detection area may be independent from the first detection area.

The processor may be configured to stop the driving of the autonomous vehicle when a detection signal is received from either one of the first sensor and the second sensor and start the driving of the autonomous vehicle again when a detection signal is not received from the first sensor and the second sensor.

The processor may be configured to request the driving signal for driving permission from the control server when the detection signal is received for a predetermined time or more in a state in which the driving has been stopped by the detection signal.

The processor may be configured to change the first detection area of the first sensor in response to a driving direction of the autonomous vehicle if the driving direction of the autonomous vehicle is changed and the first sensor may be configured to detect objects disposed in the changed first detection area.

In a case in which a driving zone of the autonomous vehicle is changed or in a case in which the autonomous vehicle enters a designated zone, the processor may be configured to request the driving signal from the control server before the autonomous vehicle enters the changed zone or the designated zone and control the autonomous vehicle to drive without stopping when receiving the driving signal.

The processor may be configured to receive driving signals from the control server, wherein the driving signals are sequentially transmitted according to a driving sequence set by the control server and apply a control signal, based on the driving signals, to restart the autonomous driving operation.

In a general aspect, here is provided a method of controlling a system for avoiding a collision of an autonomous vehicle including searching, by a first sensor, for objects disposed in a first detection area, searching, by a second sensor, for common vehicles disposed in a second detection area, controlling, by a processor, an autonomous driving operation of the autonomous vehicle by distinguishing between an object detected by the first sensor and a common vehicle detected by the second sensor, and controlling, by the processor, an entry of the autonomous vehicle into any one zone of a plurality of zones set within a driving space in response to a driving signal that is received from a control server when the autonomous vehicle enters the any one zone.

The controlling of the autonomous driving operation may include applying a control signal to stop the autonomous vehicle when receiving a detection signal from one of the first sensor and the second sensor while the autonomous vehicle is in motion and applying a control signal to restart the autonomous driving operation of the autonomous vehicle responsive to no longer receiving the detection signal from both of the first sensor and the second sensor.

The controlling of the autonomous driving operation may include requesting a driving signal for driving permission from the control server when receiving the detection signal for a period of time greater than or equal to a predetermined time in a stopped state in which the driving of the autonomous vehicle is stopped by the control signal and controlling the autonomous vehicle to restart the autonomous driving operation responsive to receiving the driving signal.

The method may include changing the first detection area of the first sensor in response to a change in a driving direction of the autonomous vehicle during the autonomous driving operation and searching for second objects disposed in the changed first detection area.

The controlling of the entry of the autonomous vehicle may include transmitting, to the control server, a request for driving permission before the autonomous vehicle enters the any one of the plurality of zones and instructing the autonomous vehicle to enter the any one zone without stopping responsive to receiving the driving permission.

The controlling of the entry of the autonomous vehicle may include stopping the driving of the autonomous vehicle before the autonomous vehicle enters the any one of the plurality of zones, transmitting, to the control server, a request for driving permission, and instructing the autonomous vehicle to enter the any one zone responsive to receiving the driving permission.

The controlling of the entry of the autonomous vehicle may include requesting the driving permission from the control server in one of a first case in which a zone in which the autonomous vehicle drives, among the plurality of zones, is changed and a second case in which the autonomous vehicle enters a designated zone, among the plurality of zones.

The searching for the common vehicle may include identifying, by the second sensor, an indication part provided on the common vehicle, the indication part having a predetermined reflectance.

In a general aspect, here is provided an apparatus including a first sensor configured to detect one or more objects disposed in a first detection area, a second sensor configured to detect one or more common vehicles disposed in a second detection area, and a processor configured to control an autonomous driving operation of an autonomous vehicle employing the apparatus by distinguishing between an object detected by the first sensor and a common vehicle detected by the second sensor and control an entry of the autonomous vehicle through an autonomous driving operation into a zone of a plurality of zones responsive to receiving a driving signal from a control server.

The first sensor may be configured to change a shape of the first detection area responsive to a change in the autonomous driving operation.

The second sensor may include a LIDAR detector configured to detect a laser reflection from reflective indication parts provided on the common vehicles.

### BRIEF DESCRIPTION OF THE DRAWINGS

FIG. 1 is an exemplary diagram illustrating vehicle types in a system for avoiding a collision of an autonomous vehicle according to an embodiment of the present disclosure.

FIG. 2 is a block diagram illustrating a control construction of the system for avoiding a collision of an autonomous vehicle according to an embodiment of the present disclosure.

FIG. 3 is a diagram to which reference is made to describe detection areas of a sensor of the system for avoiding a collision of an autonomous vehicle according to an embodiment of the present disclosure.

FIG. 4 is an exemplary diagram to which reference is made to describe collision situations in the system for avoiding a collision of an autonomous vehicle according to an embodiment of the present disclosure.

FIG. 5 is a diagram to which reference is made to describe the setting of zones within a space in which an autonomous vehicle according to an embodiment of the present disclosure drives.

FIG. 6 is a diagram to which reference is made to describe driving control by the collision avoidance system of an autonomous vehicle according to an embodiment of the present disclosure when the autonomous vehicle enters a zone.

FIG. 7 is a diagram to which reference is made to describe a method of entering, by the collision avoidance system of an autonomous vehicle according to an embodiment of the present disclosure, a designated zone.

FIG. 8 is a diagram to which reference is made to describe driving control according to a change in the driving direction of an autonomous vehicle by the collision avoidance system according to an embodiment of the present disclosure.

FIG. 9 is a flowchart illustrating a control method of the collision avoidance system of an autonomous vehicle according to an embodiment of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

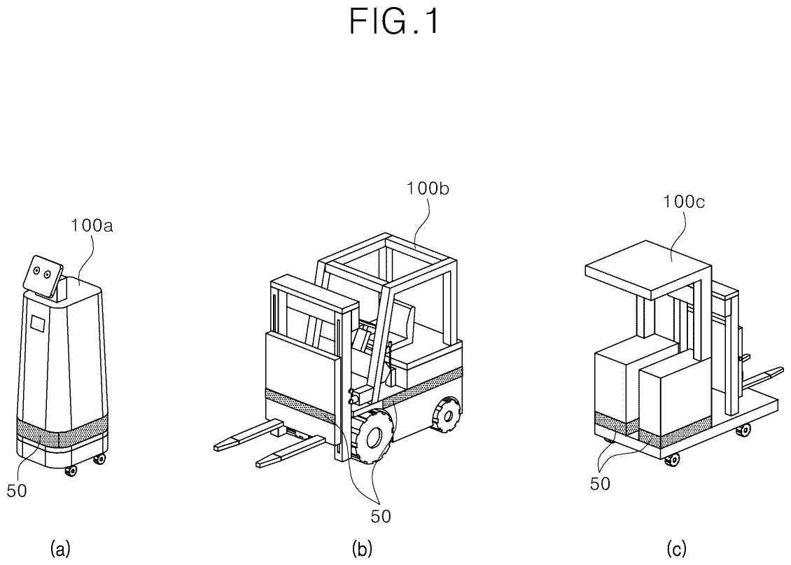

FIG. 1 is an exemplary diagram illustrating vehicle types in a system for avoiding a collision of an autonomous vehicle according to an embodiment of the present disclosure.

As illustrated in FIG. 1, the system for avoiding a collision of an autonomous vehicle (hereinafter referred to as a “collision avoidance system”) is provided in a vehicle that drives through a predetermined space.

The vehicle equipped with the collision avoidance system may include an autonomous vehicle or an autonomous robot. Furthermore, the vehicle equipped with the collision avoidance system may include a vehicle or a cart that is driven by a user.

As illustrated in FIG. 1(a), the collision avoidance system may be provided in an autonomous robot 100a that drives based on a charging current of a battery.

Furthermore, as illustrated in FIGS. 1(b) and 1(c), the collision avoidance system may be provided in vehicles 100b and 100c for tasks, such as a forklift.

A vehicle and a common vehicle each equipped with the collision avoidance system each include an indication part 50.

The indication part 50 is attached to a middle and lower part of the vehicle and has a single color. For example, the indication part 50 may be made of white paper. It is preferred that kent paper, among types of white paper, is attached to the indication part 50 by considering reflectance. Furthermore, a reflective sheet having predetermined reflectance may be attached to the indication part 50.

The collision avoidance system detects a surrounding object by detecting a surrounding area, and also distinguishes between a surrounding object and a vehicle by detecting the indication part 50.

The collision avoidance system includes a dedicated sensor for detecting the indication part 50, and detects the indication part 50 of another vehicle. The dedicated sensor is based on a laser, and may detect the indication part 50 having a single color by ignoring a surrounding object.

The collision avoidance system includes the dedicated sensor and a sensor for detecting an object, detects a surrounding object by limiting a detection area of the sensor for detecting an object, and detects a vehicle through the dedicated sensor. The dedicated sensor and the sensor for detecting an object have different sizes of detection area and different shapes.

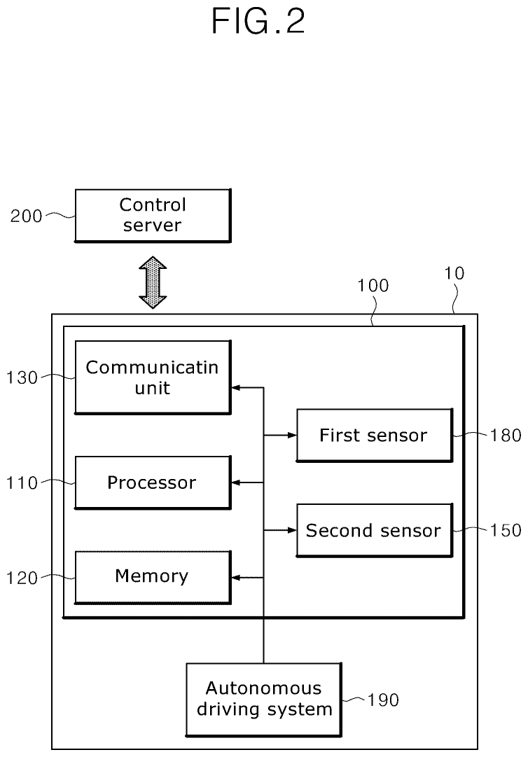

FIG. 2 is a block diagram illustrating a control construction of the collision avoidance system according to an embodiment of the present disclosure.

As illustrated in FIG. 2, the collision avoidance system 100 controls the driving of an autonomous vehicle through communication with a control server 200.

The collision avoidance system 100 controls an autonomous vehicle 10 that drives through a plurality of zones set within a predetermined space.

The collision avoidance system 100 recognizes the indication part 50 of another vehicle and applies a signal to an autonomous driving system 190 of the another vehicle.

In any one of a case in which the collision avoidance system 100 enters another zone, among the plurality of zones, and a case in which the collision avoidance system 100 enters a designated zone, among the plurality of zones, the collision avoidance system 100 requests driving permission from the control server 200 by transmitting a signal to the control server 200 before entering the another zone or the designated zone. When receiving a driving signal from the control server 200, the collision avoidance system 100 applies the driving signal to the autonomous driving system 190 so that the autonomous vehicle 10 drives.

The control server 200 determines whether the autonomous vehicle 10 will drive and a driving sequence through communication with the collision avoidance system 100, and transmits a driving signal to the collision avoidance system 100.

The control server 200 determines whether the autonomous vehicle 10 will drive and the driving sequence, based on information of another collision avoidance system that is adjacent to the collision avoidance system 100 based on characteristics of a zone that the autonomous vehicle 10 enters. In response to any one of a case in which the autonomous vehicle 10 equipped with the collision avoidance system 100 enters a specific zone, a case in which driving paths overlap, and a case in which the autonomous vehicle 10 enters a designated zone, the control server 200 generates a driving signal based on characteristics of a zone that the autonomous vehicle 10 enters, and transmits the driving signal to the collision avoidance system 100.

The collision avoidance system 100 includes a communication unit 130, memory 120, a first sensor 180, a second sensor 150, and a processor 110.

The first sensor 180 detects a surrounding object that is located within a set first detection area, and inputs a detection signal to the processor 110. The first sensor 180 detects a worktable or a work product loaded on a worktable, in addition to another vehicle within a space. A sensor for detecting an object may be used as the first sensor 180.

The second sensor 150 is a dedicated sensor for detecting the indication part 50.

The second sensor 150 detects the indication part 50 and inputs a detection signal to the processor 110. The second sensor 150 recognizes the indication part 50 based on a signal that is incident thereon by being reflected by the indication part 50. The second sensor 150 may detect a vehicle in which the indication part 50 has been formed, except a surrounding object such as a work product.

A LIDAR sensor may be used as each of the first sensor 180 and the second sensor 150. Any sensor for detecting an object by using ultrasonic waves, infrared light, or a laser may be applied as the first sensor 180.

The autonomous driving system 190 of the autonomous vehicle 10 controls the autonomous vehicle 10 to drive or stop in response to a control signal from the processor 110.

The memory 120 stores data of a plurality of zones set within a space, data of a designated zone, and data of an available driving area. The memory 120 stores information on the location of a specific destination and data of a worktable. The memory 120 stores data of a detected object and another vehicle and data of a driving path and a driving record.

Furthermore, the memory 120 stores an object detection algorithm, a vehicle detection algorithm, and an avoidance algorithm.

The memory 120 includes nonvolatile memory, such as random access memory (RAM), ROM, and electrically erased programmable ROM (EEPROM) and storage means, such as flash memory.

The communication unit 130 transmits and receives signals within the collision avoidance system 100, and communicates with the control server 200. The communication unit 130 applies a detection signal of the first sensor 180 and the second sensor 150 to the processor 110, and applies a control signal from the processor 110 to the memory 120 and the autonomous driving system 190.

The communication unit 130 communicates with the control server 200 by using a wired or wireless communication method. The communication unit 130 transmits, to the control server 200, a signal generated by the processor 110, receives a driving signal from the control server 200, and applies the driving signal to the processor 110.

The communication unit 130 includes a driver for controller area network (CAN) communication or a driver for local interconnect network (LIN) communication, and transmits and receives data.

Furthermore, the communication unit 130 includes a wired or wireless communication module, and may communicate with the control server 200 or a portable terminal. For example, the communication unit 130 includes at least one of short-distance communication such as Ethernet, Wi-Fi, and Bluetooth, mobile communication, and serial communication.

The processor 110 applies a control signal to the autonomous driving system 190 in order to change a driving direction of the autonomous vehicle or so that the autonomous vehicle drives by avoiding an object, in accordance with the object that is detected through the first sensor 180.

Furthermore, the processor 110 transmits a control signal for another vehicle that is detected through the second sensor 150, that is, an obstacle, to the autonomous driving system 190 so that the autonomous vehicle 10 stops its driving or continues to drive, in accordance with the another vehicle.

When the autonomous vehicle 10 enters a new zone while driving or the autonomous vehicle 10 enters a designated zone, the processor 110 expects the entry of the autonomous vehicle 10 into a corresponding zone based on a map, and requests driving permission from the control server 200 by transmitting a signal to the control server 200 before the autonomous vehicle 10 enters the corresponding zone. When receiving a driving signal from the control server 200, the processor 110 applies a control signal to the autonomous driving system 190 so that the autonomous vehicle 10 continues to drive without stopping.

According to circumstances, when the autonomous vehicle 10 enters a new zone while driving or the autonomous vehicle 10 enters a designated zone, the processor 110 applies a control signal to the autonomous driving system 190 so that the autonomous vehicle 10 stops, generates a signal, and transmits the signal to the control server 200 through the communication unit 130. When receiving a driving signal from the control server 200 in response to the signal, the processor 110 controls the autonomous vehicle 10 to drive by applying a control signal to the autonomous driving system 190.

The processor 110 determines a change in the zone that the autonomous vehicle 10 enters or whether the autonomous vehicle 10 will enter a designated zone, based on zone setting data stored in the memory 120.

Furthermore, the processor 110 determines whether a zone through which the autonomous vehicle 10 drives is changed or whether the autonomous vehicle 10 enters a designated zone by receiving a signal from a boundary line notification device installed within a space or detecting a boundary line that is indicated at a floor within the space through the sensor.

Furthermore, the processor 110 may identify a zone based on data that are received from the control server 200.

With respect to another vehicle that is detected though the second sensor 150 while the autonomous vehicle 10 drives, the processor 110 determines whether the another vehicle is located in a driving direction of the autonomous vehicle or on a driving path thereof, or determines whether there is the possibility of a collision between the another vehicle and the autonomous vehicle 10 because the driving path of the autonomous vehicle 10 overlaps a driving path of the another vehicle.

When there is the possibility of the collision, the processor 110 controls the autonomous vehicle 10 to drive by avoiding the another vehicle or transmits a signal to the control server 200 so that the control server 200 determines a driving sequence of the autonomous vehicle 10 and the another vehicle and the autonomous vehicle 10 and the another vehicle drive according to the driving sequence.

In response to a detected another vehicle or a change in the driving direction of the autonomous vehicle 10 while the autonomous vehicle 10 drives, the processor 110 may change detection areas of the first sensor 180 and the second sensor 150.

When another vehicle or an object is detected in changed detection areas of the first sensor 180 and the second sensor 150, the processor 110 may change the driving path of the autonomous vehicle 10 or transmit a signal to the control server 200, in response to the detection.

When not receiving a driving signal from the control server 200 after transmitting a signal to the control server 200 through the communication unit 130, the processor 110 applies a control signal to the autonomous driving system 190.

Accordingly, the autonomous vehicle 10 maintains a stop state because the autonomous driving system 190 has the possibility of a collision with another vehicle. The processor 110 may transmit a driving state to the control server 200 through the communication unit 130, and may also transmit the driving state to a designated terminal.

The processor 110 controls the driving of the autonomous vehicle by operating according to a control algorithm stored in the memory. According to circumstances, the processor 110 may include a motor controller 140.

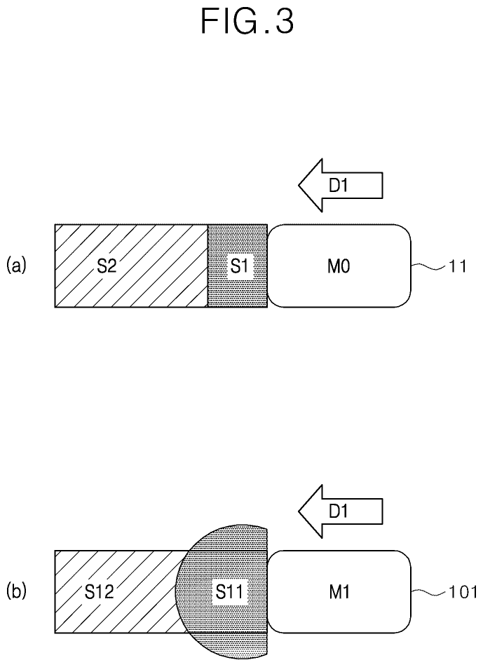

FIG. 3 is a diagram to which reference is made to describe detection areas of the sensor of the collision avoidance system according to an embodiment of the present disclosure.

A conventional vehicle 11 stops its driving when detecting a surrounding obstacle, for example, a worktable or luggage. Accordingly, an unnecessary and frequent stop may reduce efficiency of a work.

Accordingly, as illustrated in FIG. 3(a), the conventional vehicle 11 drives by limiting the size of a detection area S1 and S2 of a sensor. The vehicle 11 sets the width of the detection area based on the width of the main body of the vehicle, sets the detection area by dividing the detection area into an emergency stop area S1 and a deceleration detection area S2, and detects an object.

If the width of the detection area is set to be identical with the width of the vehicle, the stop of the driving of the vehicle attributable to a surrounding object can be prevented because a worktable or luggage at a location adjacent to the vehicle is not detected while the vehicle drives. However, a collision accident between the vehicle and the worktable or luggage may occur because the vehicle does not detect another vehicle although the another vehicle is located at a location adjacent to the vehicle.

As illustrated in FIG. 3(b), the collision avoidance system 100 according to an embodiment of the present disclosure detects a surrounding another vehicle by setting a deceleration detection area S12 of the first sensor 180 in accordance with the width of the autonomous vehicle, but expanding an emergency stop area S11 of the second sensor 150. The deceleration detection area S12 is a first detection area of the first sensor 180 for detecting an object. The emergency stop area S11 is a second detection area of the second sensor 150.

The second detection area, that is, the emergency stop area S11, is more expanded than a conventional area, and is formed in a semicircular form. The emergency stop area S11 is formed within a range of 180 degrees ahead of the autonomous vehicle 101, and is used to detect another vehicle. The second sensor 150 may detect another vehicle including the indication part 50 in the emergency stop area S11.

When another vehicle is detected in the emergency stop area S11, the processor 110 determines that there is the possibility of a collision with the detected another vehicle even without the intervention of the control server 200, and applies a control signal to the autonomous driving system 190. The autonomous driving system 190 immediately stops the driving of the autonomous vehicle 10 in response to the control signal.

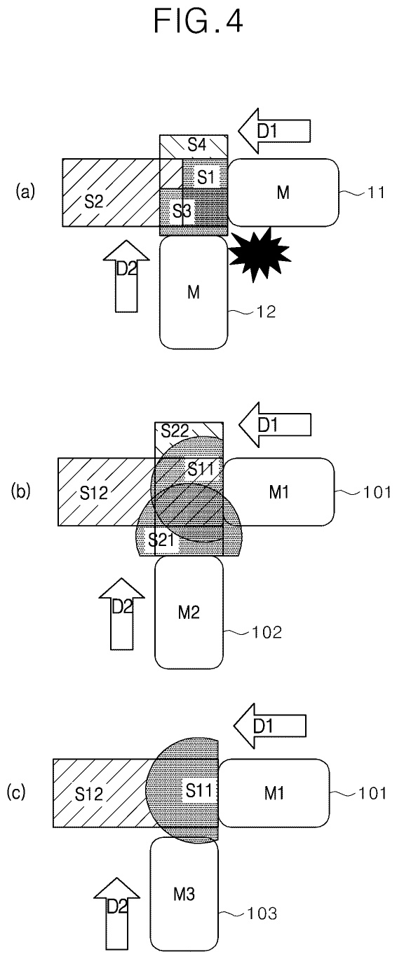

FIG. 4 is an exemplary diagram to which reference is made to describe collision situations in the collision avoidance system according to an embodiment of the present disclosure.

As illustrated in FIG. 4(a), while a conventional vehicle 11 drives in a first driving direction D1, a collision accident between the conventional vehicle 11 and a vehicle 12 that drives in another direction D2 may occur because the conventional vehicle 11 does not detect the vehicle 12 until the vehicle 12 reaches a location close to the conventional vehicle 11.

As illustrated in FIG. 4(b), a first vehicle 101 equipped with the collision avoidance system 100 forms a semicircular first detection area S11 as an emergency stop area, and detects a surrounding second vehicle 102. When the second vehicle 102 approaches the first vehicle 101 within a predetermined distance, the second sensor 150 may detect the second vehicle 102 by detecting the indication part 50 of the second vehicle 102. The second vehicle 102 may also detect the first vehicle 101 in an emergency stop area S21.

As illustrated in FIG. 4(c), if a third vehicle 103, that is, a common vehicle not equipped with a sensor for detecting surroundings is driving in a second direction D2, the first vehicle 101 equipped with the collision avoidance system 100 may detect the third vehicle 103 in an emergency stop area S11 of the second sensor 150.

When detecting another vehicle in the emergency stop area S11 of the second sensor 150, the collision avoidance system 100 applies a control signal to the autonomous driving system 190. Accordingly, the autonomous driving system 190 controls the autonomous vehicle 10 to immediately stop its driving so that the autonomous vehicle 10 does not collide against the detected vehicle. Furthermore, the collision avoidance system 100 may output an alarm sound when detecting another vehicle.

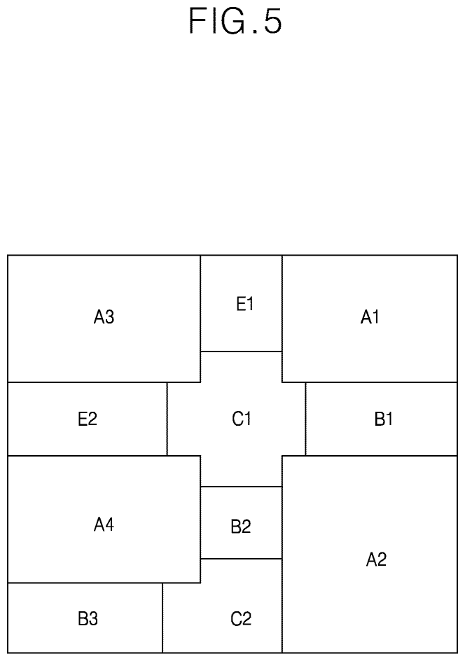

FIG. 5 is a diagram to which reference is made to describe the setting of zones within a space of the collision avoidance system of an autonomous vehicle according to an embodiment of the present disclosure.

As illustrated in FIG. 5, the space in which the autonomous vehicle drives may be set as a plurality of zones.

A zone A (A1 to A4) may be classified as a driving-impossible area. A zone B (B1 to B3), a zone C (C1 and C2), and a zone E (E1 and E2) may be classified as driving-possible areas.

Furthermore, among the driving-possible areas, the zone B may be classified as a common driving area, the zone C may be classified as a cross area, and the zone E may be classified as a designated zone.

The zone C is an area in which the direction of the autonomous vehicle is changed or the autonomous vehicle crosses with another vehicle. The zone E is an area that is set so that only a designated vehicle enters the area or only one vehicle can enter the area.

The collision avoidance system 100 stops the driving of the autonomous vehicle at a point at which a zone is changed, such as when the autonomous vehicle drives from the zone B to the zone C or enters the zone E, transmits a signal to the control server 200, and waits until a driving signal is received from the control server 200. When receiving the driving signal from the control server 200, the collision avoidance system 100 controls the autonomous vehicle to drive again along a designated path in response to the driving signal.

If another vehicle is located nearby, the control server 200 may set a passage sequence for the zone C as a driving sequence, and may sequentially transmit a driving signal to the collision avoidance system 100 according to the driving sequence.

Furthermore, when the autonomous vehicle enters the zone E while driving, the collision avoidance system 100 applies a control signal to the autonomous driving system 190. The autonomous driving system 190 stops the driving of the autonomous vehicle and waits in response to the control signal. At this time, the control server 200 may check whether the autonomous vehicle is a vehicle capable of entering the zone E or another vehicle is located in the zone E, and may transmit a driving signal to the vehicle. The collision avoidance system 100 may control the autonomous vehicle to start to drive again by transmitting a control signal to the autonomous driving system 190, in response to a driving signal that is received from the control server 200 while waiting.

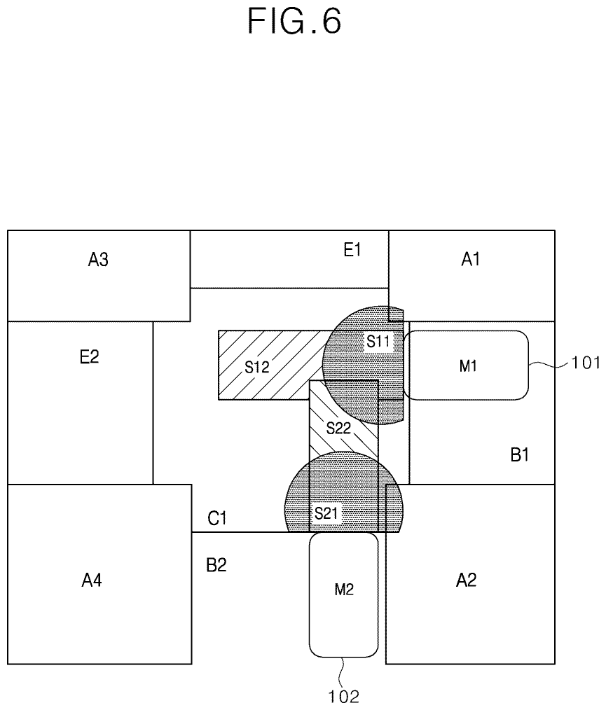

FIG. 6 is a diagram to which reference is made to describe driving control by the collision avoidance system of an autonomous vehicle according to an embodiment of the present disclosure when the autonomous vehicle enters a zone.

As illustrated in FIG. 6, when the first vehicle 101 enters the zone C1, the collision avoidance system 100 of the first vehicle 101 controls the first vehicle 101 to stop its driving in a boundary line, and transmits a signal to the control server 200 while waiting.

According to circumstances, the collision avoidance system 100 may determine that the first vehicle 101 is expected to enter the zone C1, may transmit a signal to request driving permission to the control server 200, and may control the first vehicle 101 to continuously drive without stopping when receiving a driving signal from the control server 200 before the first vehicle 101 reaches the boundary line, so that the first vehicle 101 can enter the zone C1. When not receiving the driving signal until the first vehicle 101 reaches the boundary line, the collision avoidance system 100 controls the first vehicle 101 to stop its driving at the boundary line by controlling the autonomous driving system 190.

When a second vehicle 102 enters the zone C1 in another direction, the collision avoidance system 100 of the second vehicle 102 also controls the second vehicle 102 to stop its driving, and transmits a signal to the control server 200 while waiting.

The control server 200 determines a driving sequence of the first vehicle 101 and the second vehicle 102, in response to signals that are received from the collision avoidance systems 100 of the first vehicle 101 and the second vehicle 102.

The control server 200 may determine the driving sequence based on the sequence of the signals being received, or may determine the driving sequence based on priorities set in the first and second vehicles 101 and 102. Furthermore, the control server 200 may determine the driving sequence based on the driving direction of each vehicle.

When the driving sequence is determined, the control server 200 sequentially generates driving signals based on the driving sequence, and transmits the driving signals to the collision avoidance systems 100 of the first and second vehicles 101 and 102. For example, based on the sequence of the signals being received, the control server 200 transmits, to the collision avoidance system 100 of the first vehicle 101, a driving signal that permits the driving of the first vehicle 101, and transmits, to the collision avoidance system 100 of the second vehicle 102, a driving signal that permits the driving of the second vehicle 102 so that the second vehicle 102 passes through the zone C1 after the first vehicle 101 passes through the zone C1.

Furthermore, when determining that a collision possibility is not present, the control server 200 may transmit a driving signal to the second vehicle 102 while the first vehicle 101 passes through the zone C1. For example, when the first vehicle 101 drives straight and the second vehicle 102 turns right and moves to the zone B1, the control server 200 may transmit a driving signal to the second vehicle 102 so that the second vehicle 102 starts its driving after the first vehicle 101 passes through a middle point of the zone C1.

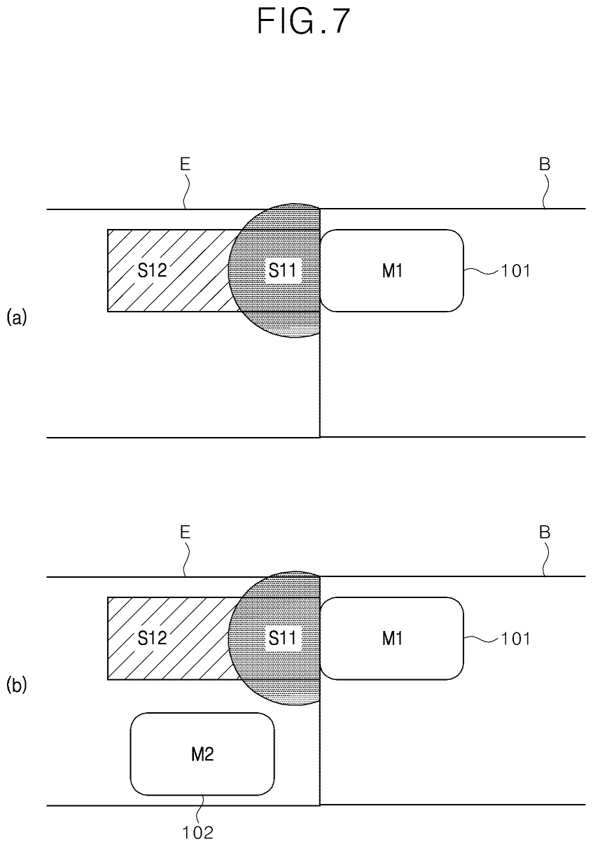

FIG. 7 is a diagram to which reference is made to describe a method of entering, by the collision avoidance system of an autonomous vehicle according to an embodiment of the present disclosure, a designated zone.

As illustrated in FIG. 7(a), when the first vehicle 101 enters a zone E from a zone B, the collision avoidance system 100 controls the first vehicle 101 to stop its driving at a boundary line between the zone B and the zone E and to wait. The collision avoidance system 100 requests driving permission from the control server 200 by transmitting a signal to the control server 200, and controls the first vehicle 101 to start its driving when receiving a driving signal from the control server 200, so that the first vehicle 101 enters the zone E.

In this case, the zone E is a designated zone, and may be an area in which a vehicle capable of entering the area has been designated or only one vehicle within the zone has been permitted at the same time.

Although an object or another vehicle that is detected through the first sensor 180 and the second sensor 150 is not present, when the first vehicle 101 enters the zone E, that is, a designated zone, the collision avoidance system 100 controls the first vehicle 101 to enter the zone E when receiving a driving signal for driving permission from the control server 200.

The control server 200 checks whether another vehicle is located in the designated zone, and then transmits the driving signal to the first vehicle 101.

Furthermore, when the first vehicle 101 enters the designated zone, the control server 200 may check whether the first vehicle 101 has authorities to enter the designated zone in response to a request signal from the first vehicle 101, and may then transmit the driving signal to the first vehicle 101.

As illustrated in FIG. 7(b), when the second vehicle 102 is located in a zone E, that is, a designated zone, the collision avoidance system 100 of the first vehicle 101 controls the first vehicle 101 to stop and wait prior to the entry of the zone E. Since the second vehicle 102 is located in the zone E, the control server 200 transmits a driving signal to the first vehicle 101 after the second vehicle 102 moves to another zone.

If a driving signal is not received from the control server 200 due to a communication error or the abnormality of the control server 200, in order to avoid a collision between the autonomous vehicle 10 and another vehicle, the collision avoidance system 100 applies a control signal to the autonomous driving system 190 so that the autonomous vehicle 10 maintains a standby state in the state in which the autonomous vehicle 10 has stopped its driving.

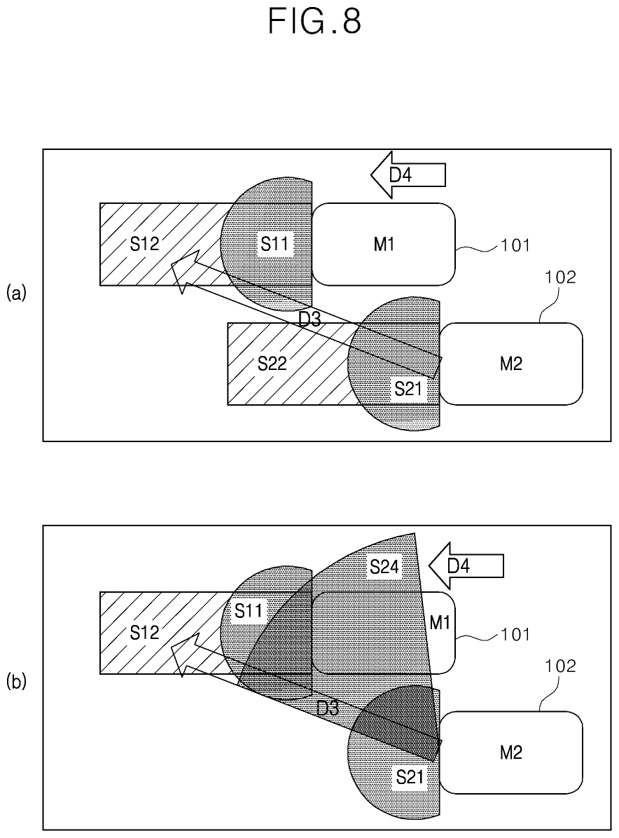

FIG. 8 is a diagram to which reference is made to describe driving control according to a change in the driving direction of an autonomous vehicle by the collision avoidance system according to an embodiment of the present disclosure.

As illustrated in FIG. 8(a), in a situation in which the first vehicle 101 and the second vehicle 102 drive in parallel to a fourth direction D4, when the second vehicle 102 changes its location by changing its driving direction into a third direction D3, there is a possibility that the second vehicle 102 may collide against the first vehicle 101 adjacent to the second vehicle 102.

The first vehicle 101 and the second vehicle 102 are driving adjacently, but are each in a situation in which a counterpart vehicle is not detected in the detection areas of the first sensor 180 and the second sensor 150. Accordingly, when the second vehicle 102 changes the driving direction, there is a possibility that the second vehicle 102 may collide against the first vehicle 101.

As illustrated in FIG. 8(b), if the second vehicle 102 attempts to change its driving direction into the third direction D3, the collision avoidance system 100 of the second vehicle 102 changes a deceleration detection area S24 of the first sensor 180, and then changes the driving direction of the second vehicle 102 by applying a control signal to the autonomous driving system 190.

The second vehicle 102 changes the deceleration detection area S24 of the first sensor 180 in accordance with the driving direction of the second vehicle 102, and then detects an object. When the first vehicle 101 is detected in the deceleration detection area S24, the collision avoidance system 100 of the second vehicle 102 applies a control signal to the autonomous driving system 190 so that the second vehicle 102 stops its driving and waits for a predetermined time. After the first vehicle 101 passes through a corresponding location, the second vehicle 102 may change its driving direction into the third direction D3 and drive in the third direction D3.

According to circumstances, after an autonomous vehicle stops its driving, the collision avoidance system 100 may transmit a signal to the control server 200 while the autonomous vehicle waits, and may control the autonomous vehicle to start to drive again when receiving driving permission from the control server 200. For example, when both the first vehicle and the second vehicle stop their driving by mutually detecting them, the collision avoidance system 100 of each of the first vehicle and the second vehicle may control each of the first vehicle and the second vehicle to start its driving according to a driving sequence that is determined after transmitting a signal to the control server 200.

At this time, if the driving of a counterpart vehicle is also stopped in the state in which the driving of one of the first vehicle and the second vehicle has been stopped in response to a detection signal from any one of the first sensor 180 and the second sensor 150, the processor 110 may request a driving signal for driving permission from the control server 200 by transmitting a signal to the control server 200 when the same detection signal is continuously received for a predetermined time or more because the detection signals are continuously received.

Furthermore, when another vehicle is being docked or parked while the first vehicle 101 drives, the collision avoidance system 100 of the first vehicle 101 controls the first vehicle 101 to change its driving direction and then to drive by avoiding a corresponding location. In this case, the first vehicle 101 changes a detection area of the first sensor 180 in accordance with the driving direction, in response to a change in the driving direction, and drives after detecting whether an object or another vehicle is located.

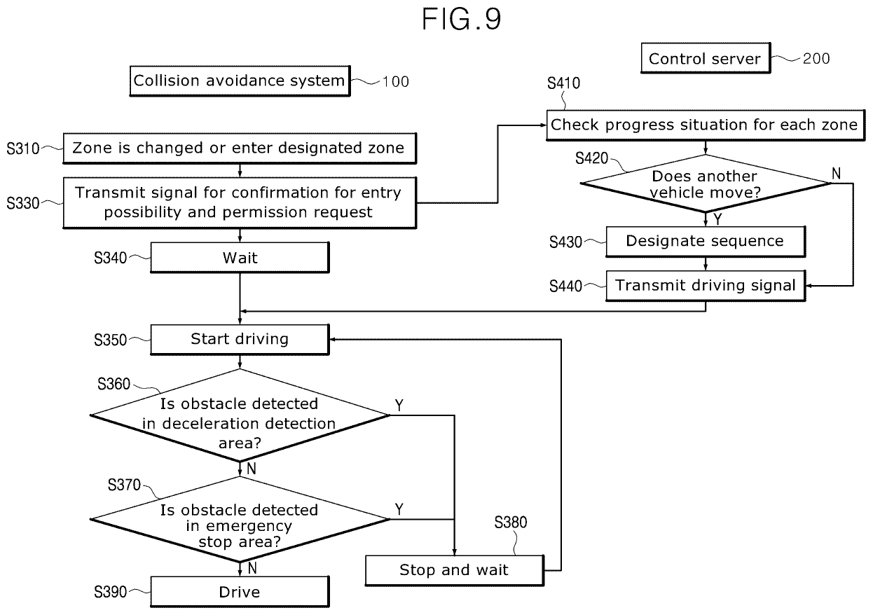

FIG. 9 is a flowchart illustrating a control method of the collision avoidance system of an autonomous vehicle according to an embodiment of the present disclosure.

As illustrated in FIG. 9, when a zone of the autonomous vehicle 10 is changed while the autonomous vehicle drives or the autonomous vehicle enters a designated zone (S310), the collision avoidance system 100 of the autonomous vehicle transmits a signal for confirmation for an entry possibility and a permission request to the control server 200 (S330).

As described above, when the autonomous vehicle enters a cross zone (e.g., the zone C) or a designated zone (e.g., the zone E) while driving, the collision avoidance system 100 may request permission from the control server 200 prior to the entry of the autonomous vehicle.

After generating a signal, the collision avoidance system 100 applies a control signal to the autonomous driving system 190. The autonomous driving system 190 waits in the state in which the autonomous vehicle 10 has stopped until a response (i.e., a driving signal) is received from the control server 200 in response to the control signal (S340).

When receiving a driving signal for entry permission from the control server 200 before the autonomous vehicle reaches a boundary point of an area, the collision avoidance system 100 may control the autonomous vehicle to continue to drive without stopping.

The control server 200 receives the request signal transmitted by the collision avoidance system 100, and checks a progress situation for each zone based on signals received from a plurality of vehicles (S410). Furthermore, the control server 200 may determine a situation for each zone through a camera (not illustrated) or a sensor (not illustrated) installed within a space.

The control server 200 checks whether another vehicle adjacent to the autonomous vehicle 10 is present on the basis of a zone that the autonomous vehicle of the collision avoidance system 100 that has transmitted the signal will enter (S420). If another vehicle is not present as a result of the check, the control server 200 transmits, to the collision avoidance system 100, a driving signal that permits the driving of the autonomous vehicle (S440).

If another vehicle is present as a result of the check, the control server 200 determines the possibility of a collision between the autonomous vehicle 10 and the another vehicle. If the possibility of the collision is not present, the control server 200 transmits a driving signal to the collision avoidance system 100 (S440).

Furthermore, the control server 200 designates a driving sequence of the plurality of vehicles having a collision possibility (S430) so that each vehicle can drive through a corresponding zone without a collision. When the driving sequence is designated, the control server 200 sequentially transmits driving signals to the collision avoidance systems 100 of the plurality of vehicles according to the sequence (S440).

When receiving the driving signal from the control server 200, the collision avoidance system 100 applies a control signal to the autonomous driving system 190. The autonomous driving system 190 controls the autonomous vehicle 10 to start its driving (S350) in response to the control signal.

In this case, when a driving signal is not received due to a communication error or the abnormality of the control server 200, the collision avoidance system 100 applies a control signal to the autonomous driving system 190 so that the autonomous vehicle maintains its stop state.

Furthermore, when a zone of the autonomous vehicle 10 is changed or the autonomous vehicle enters a designated zone while driving, the collision avoidance system 100 requests a driving signal from the control server 200 by transmitting a signal to the control server 200 before the autonomous vehicle enters the zone. When receiving the driving signal before the autonomous vehicle enters the zone, the collision avoidance system 100 transmits a control signal to the autonomous driving system 190 so that the autonomous vehicle can immediately enter the changed zone or the designated zone without stopping.

The collision avoidance system 100 may detect an object or another vehicle through the first sensor 180 and the second sensor 150 while the autonomous vehicle drives.

When an obstacle (or an object) is detected in a deceleration detection area of the first sensor 180 while the autonomous vehicle 10 drives (S360), the collision avoidance system 100 controls the autonomous vehicle to stop its driving and to wait in the stop state (S380).

Furthermore, when an obstacle (e.g., a vehicle) is detected in an emergency stop area of the second sensor 150 (S370) while the autonomous vehicle 10 drives, the collision avoidance system 100 controls the autonomous vehicle 10 to stop its driving and wait in the stop state (S380). The collision avoidance system 100 separately recognizes an object and a vehicle by detecting the indication part 50, which has been formed in each vehicle, through the second sensor 150.

If an object or a vehicle is not detected in the emergency stop area of the second sensor 150, the collision avoidance system 100 applies a control signal to the autonomous driving system 190 so that the autonomous vehicle 10 drives along a set path (S390).

At this time, when both the vehicles are in the stop state due to the detection of the vehicle through the sensor, the collision avoidance system 100 may transmit a signal to the control server 200 so that the vehicles drive according to a driving sequence that is set by the control server 200.

Furthermore, if the vehicle attempts to change its driving direction, the collision avoidance system 100 may change a detection area of the first sensor 180, may detect whether an object is present in the driving direction of the vehicle, and may apply a control signal to the autonomous driving system 190 so that the vehicle changes the driving direction.

Accordingly, according to the collision avoidance system and the control method thereof according to aspects of the present disclosure, a vehicle can be easily recognized by distinguishing between an object and the vehicle through the indication part installed in each of a plurality of vehicles that drives within a predetermined space. The vehicle can continue to drive without unnecessary stopping. When another vehicle is detected, the vehicle can drive by avoiding the another vehicle or drive in response to a signal from the control server. Accordingly, a collision between the vehicles can be prevented.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A system for avoiding a collision of an autonomous vehicle that drives through a space in which a plurality of zones have been set, the system comprising:
a first sensor configured to detect objects disposed in a first detection area;
a second sensor configured to detect another vehicle disposed in a second detection area; and
a processor configured to:
control an autonomous driving operation of the autonomous vehicle by distinguishing between an object detected by the first sensor and the another vehicle detected by the second sensor; and
control an entry of the autonomous vehicle through the autonomous driving operation into any one zone of the plurality of zones in response to a driving signal that is received from a control server.

2. The system of claim 1, wherein the autonomous vehicle and the another vehicle each comprise an indication part, and
wherein the second sensor is configured to detect the another vehicle by detecting the indication part of the another vehicle.

3. The system of claim 2, wherein the indication part comprises a reflective material.

4. The system of claim 2, wherein the second sensor is a LIDAR sensor that detects the indication part, and
wherein the second detection area is independent from the first detection area.

5. The system of claim 1, wherein the processor is further configured to:
stop the driving of the autonomous vehicle when a detection signal is received from either one of the first sensor and the second sensor; and
start the driving of the autonomous vehicle again when a detection signal is not received from the first sensor and the second sensor.

6. The system of claim 5, wherein the processor is further configured to request the driving signal for driving permission from the control server when the detection signal is received for a predetermined time or more in a state in which the driving has been stopped by the detection signal.

7. The system of claim 1, wherein the processor changes the first detection area of the first sensor in response to a driving direction of the autonomous vehicle if the driving direction of the autonomous vehicle is changed, and
wherein the first sensor is further configured to detect objects disposed in the changed first detection area.

8. The system of claim 1, wherein, in a case in which a driving zone of the autonomous vehicle is changed or in a case in which the autonomous vehicle enters a designated zone, the processor is further configured to:
request the driving signal from the control server before the autonomous vehicle enters the changed zone or the designated zone; and
control the autonomous vehicle to drive without stopping when receiving the driving signal.

9. The system of claim 8, wherein the processor is further configured to:
receive driving signals from the control server, wherein the driving signals are sequentially transmitted according to a driving sequence set by the control server; and
apply a control signal, based on the driving signals, to restart the autonomous driving operation.

10. A method of controlling a system for avoiding a collision of an autonomous vehicle, the method comprising:
searching, by a first sensor, for objects disposed in a first detection area;
searching, by a second sensor, for common vehicles disposed in a second detection area;
controlling, by a processor, an autonomous driving operation of the autonomous vehicle by distinguishing between an object detected by the first sensor and a common vehicle detected by the second sensor; and
controlling, by the processor, an entry of the autonomous vehicle into any one zone of a plurality of zones set within a driving space in response to a driving signal that is received from a control server when the autonomous vehicle enters the any one zone.

11. The method of claim 10, wherein the controlling of the autonomous driving operation comprises:
applying a control signal to stop the autonomous vehicle when receiving a detection signal from one of the first sensor and the second sensor while the autonomous vehicle is in motion; and
applying a control signal to restart the autonomous driving operation of the autonomous vehicle responsive to no longer receiving the detection signal from both of the first sensor and the second sensor.

12. The method of claim 11, wherein the controlling of the autonomous driving operation further comprises:
requesting a driving signal for driving permission from the control server when receiving the detection signal for a period of time greater than or equal to a predetermined time in a stopped state in which the driving of the autonomous vehicle is stopped by the control signal; and
controlling the autonomous vehicle to restart the autonomous driving operation responsive to receiving the driving signal.

13. The method of claim 10, further comprising:
changing the first detection area of the first sensor in response to a change in a driving direction of the autonomous vehicle during the autonomous driving operation; and
searching for second objects disposed in the changed first detection area.

14. The method of claim 10, wherein the controlling of the entry of the autonomous vehicle comprises:
transmitting, to the control server, a request for driving permission before the autonomous vehicle enters the any one of the plurality of zones; and
instructing the autonomous vehicle to enter the any one zone without stopping responsive to receiving the driving permission.

15. The method of claim 10, wherein the controlling of the entry of the autonomous vehicle comprises:
stopping the driving of the autonomous vehicle before the autonomous vehicle enters the any one of the plurality of zones;
transmitting, to the control server, a request for driving permission; and
instructing the autonomous vehicle to enter the any one zone responsive to receiving the driving permission.

16. The method of claim 15, wherein the controlling of the entry of the autonomous vehicle further comprises:
requesting the driving permission from the control server in one of a first case in which a zone in which the autonomous vehicle drives, among the plurality of zones, is changed and a second case in which the autonomous vehicle enters a designated zone, among the plurality of zones.

17. The method of claim 10, wherein the searching for the common vehicle comprises identifying, by the second sensor, an indication part provided on the common vehicle, the indication part having a predetermined reflectance.

18. An apparatus, comprising:
a first sensor configured to detect one or more objects disposed in a first detection area;
a second sensor configured to detect one or more common vehicles disposed in a second detection area; and
a processor configured to:
control an autonomous driving operation of an autonomous vehicle comprising the apparatus by distinguishing between an object detected by the first sensor and a common vehicle detected by the second sensor; and
control an entry of the autonomous vehicle through an autonomous driving operation into a zone of a plurality of zones responsive to receiving a driving signal from a control server.

19. The apparatus of claim 18, wherein the first sensor is further configured to change a shape of the first detection area responsive to a change in the autonomous driving operation.

20. The apparatus of claim 18, wherein the second sensor comprises a LIDAR detector configured to detect a laser reflection from reflective indication parts provided on the common vehicles.
